(19) United States
(12) Patent Application Publication
(10) Pub. No.: US 2010/0014014 A1
(43) Pub. Date: Jan. 21, 2010

(54) LIQUID CRYSTAL DISPLAY

(76) Inventor: Dong-Gyu Kim, Yongin-si (KR)

Correspondence Address: Frank Chau, Esq.;F. CHAU & ASSOCIATES, LLC, 130 Woodbury Road, Woodbury, NY, 11797, US

(21) Appl. No.: 12/328,397

(22) Filed: Dec. 4, 2008

(30) Foreign Application Priority Data
Jul. 16, 2008 (KR) 10-2008-0069114

(51) Int. Cl. G02F 1/1347; G09G 3/36

(52) U.S. Cl. 349/42; 345/87

(57) ABSTRACT

A liquid crystal display including a plurality of pixels arranged in a matrix shape, each of the pixels having a length in a row direction less than a length in a column direction, a plurality of gate lines extending in the column direction, a plurality of data lines extending in the row direction, a gate driver connected to the gate lines and generating a gate signal, a data driver connected to the data lines and transmitting a data signal, wherein two adjacent gate lines are connected to each other to form a plurality of pairs of gate lines.

### CROSS-REFERENCE TO RELATED APPLICATION

This application claims priority to Korean Patent Application No. 10-2008-0069114 filed in the Korean Intellectual Property Office on Jul. 16, 2008, the entire contents of which are incorporated herein by reference.

### BACKGROUND OF THE INVENTION

(a) Technical Field

The present invention relates to a liquid crystal display.

(b) Discussion of the Related Art

A liquid crystal display is one type of flat panel display that is now widely used. The liquid crystal display includes two display panels in which field generating electrodes such as pixel electrodes and a common electrode are formed, and a liquid crystal layer interposed between the display panels. In the liquid crystal display, voltages are applied to the field generating electrodes to generate an electric field in the liquid crystal layer. The electric field determines orientation of liquid crystal molecules of the liquid crystal layer such that a polarization of incident light in the liquid crystal layer is changed, thereby displaying an image.

The liquid crystal display also includes a plurality of thin film transistors connected to the pixel electrode, a plurality of gate lines and data lines for controlling the thin film transistors, a gate driver, and a data driver.

In the liquid crystal display, the gate driver sequentially generates simple signals such that the structure thereof may be relatively simple and the costs associated with the gate driver are low. However, the data driver performs more complicated functions such as converting a digital signal into an analog signal such that the structure thereof is relatively complex, and the costs associated with the data driver are high.

### SUMMARY OF THE INVENTION

The embodiments of the present invention simplify the structure of a data driver in a liquid crystal display to reduce manufacturing costs.

A liquid crystal display according to an exemplary embodiment of the present invention includes a plurality of pixels arranged in a matrix shape, each of the pixels having a length in a row direction less than a length in a column direction, a plurality of gate lines extending in the column direction, a plurality of data lines extending in the row direction, a gate driver connected to the gate lines and generating a gate signal, and a data driver connected to the data lines and transmitting data signals, wherein two adjacent gate lines are connected to each other to form a plurality of pairs of gate lines.

A liquid crystal display according to an exemplary embodiment of the present invention includes a plurality of pixels arranged in a matrix shape, each of the pixels having a length in a row direction less than a length in a column direction, a plurality of gate lines extending in the column direction, a plurality of data lines extending in the row direction, a gate driver connected to the gate lines and generating a gate signal, and a data driver connected to the data lines and transmitting data signals, wherein the gate driver has output terminals, and a number of the output terminals is less than a number of the gate lines.

The number of the output terminals of the gate driver may be half the number of the gate lines.

Two neighboring gate lines may be connected to one output terminal of the gate driver.

The gate driver may include a plurality of thin film transistors.

Two data lines may be disposed along the same pixel row, and connected to pixels in the same pixel row.

The two data lines may be respectively disposed above and below the same pixel row, and may be disposed on the same plane.

Each of the pixels may include a switching element connected to the gate line and the data line and a liquid crystal capacitor connected to the switching element, and the switching element may be alternately disposed at a top of the pixel and at a bottom of the pixel in each pixel row.

Each pixel may further include a storage capacitor connected to the switching element in parallel with the liquid crystal capacitor.

The liquid crystal display may further include a plurality of storage electrode lines extending in the column direction, and each of the pixels may include a switching element connected to the gate line and the data line, and a pixel electrode connected to the switching element and overlapping the storage electrode line.

The storage electrode line may include a storage electrode extending along an edge of the pixel electrode an overlapping the pixel electrode.

### BRIEF DESCRIPTION OF THE DRAWINGS

Exemplary embodiments of the present invention can be understood in more detail from the following descriptions taken in conjunction with the accompanying drawings in which:

FIG. 1 is a block diagram of a liquid crystal display according to an exemplary embodiment of the present invention.

FIG. 2 is a schematic diagram of a liquid crystal panel assembly in the liquid crystal display shown in FIG. 1.

FIG. 3 is an equivalent circuit diagram of one pixel in the liquid crystal panel assembly shown in FIG. 2.

FIG. 4 is a layout view of a liquid crystal panel assembly according to an exemplary embodiment of the present invention.

FIG. 5 is a cross-sectional view of the liquid crystal panel assembly shown in FIG. 4 taken along the line V-V.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

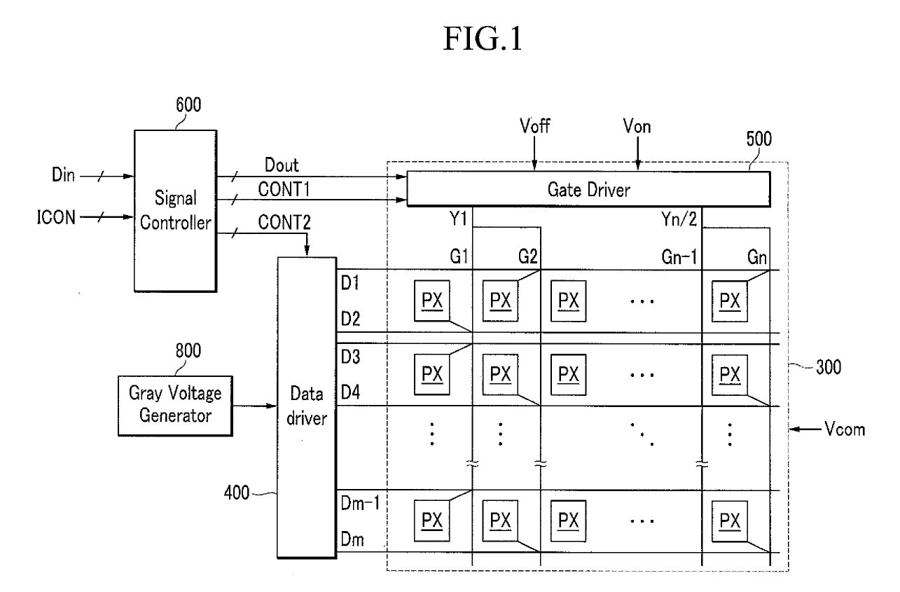

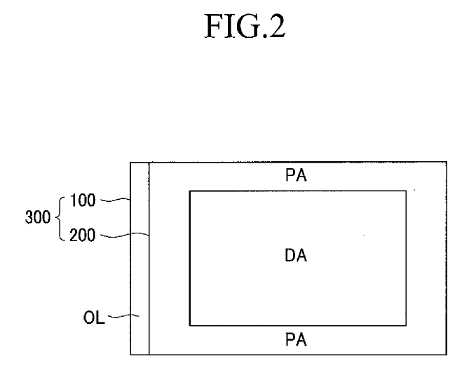

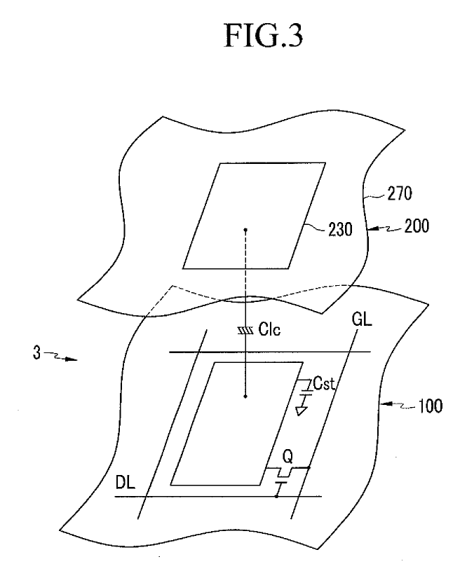

FIG. 1 is a block diagram of a liquid crystal display according to an exemplary embodiment of the present invention, FIG. 2 is a schematic diagram of a liquid crystal panel assembly in the liquid crystal display shown in FIG. 1, and FIG. 3 is an equivalent circuit diagram of one pixel in the liquid crystal panel assembly shown in FIG. 2.

As shown in FIG. 1, a liquid crystal display according to an exemplary embodiment of the present invention includes a liquid crystal panel assembly 300, a data driver 400, a gate driver 500, a gray voltage generator 800, and a signal controller 600.

Referring to FIG. 1, the liquid crystal panel assembly 300 includes a plurality of signal lines G1-Gn and D1-Dm, and a plurality of pixels PX that are connected to the plurality of signal lines and are arranged in an approximate matrix shape. Referring to the structure shown in FIG. 2 and FIG. 3, the liquid crystal panel assembly 300 includes lower and upper display panels 100 and 200 that face each other, and a liquid crystal layer 3 disposed therebetween. The lower panel 100 is larger than the upper panel 200 and includes a display area DA, a peripheral area PA, and a pad region OL. The pixels PX are located in the display area, and the pad region OL does not overlap the upper panel 200.

The signal lines G1-Gn and D1-Dm include a plurality of gate lines G1-Gn that transmit gate signals, and a plurality of data lines D1-Dm that transmit data voltages. Gate lines are respectively disposed along respective pixel columns, and two neighboring gate lines are connected to each other. For example, referring to FIG. 1, a gate line G1 is disposed along a first pixel column and connected to pixels PX in the first pixel column, and a gate line G2 is disposed along a second pixel column and connected to pixels PX in the second column. The adjacent gate lines G1 and G2 are connected to each other. A plurality of data lines, for example, two data lines D1 and D2, D3 and D4 or Dm-1 and Dm, are disposed along the same pixel rows, respectively. The data lines D1 and D2, D3 and D4 or Dm-1 and Dm, for example, are disposed above and below the same respective pixel rows on the same plane and connected to pixels PX of the respective pixel rows. The gate lines G1-Gn substantially extend in a longitudinal direction and are parallel to each other, and the data lines D1-Dm substantially extend in a transverse direction and are parallel to each other. The gate lines pass through the display area DA and the peripheral area PA, while the data lines pass through the display area DA, the peripheral area PA, and the pad region OL, and are connected to the data driver 400 in the pad region OL.

Each pixel PX includes a switching element Q, a liquid crystal capacitor Clc, and a storage capacitor Cst. The storage capacitor Cst may be omitted.

The switching element Q is a three terminal element such as a thin film transistor provided on the lower panel 100. The control terminal of the switching element Q is connected to the gate line GL, the input terminal thereof is connected to a data line DL, and the output terminal thereof is connected to the liquid crystal capacitor Clc and the storage capacitor Cst.

The liquid crystal capacitor Clc uses a pixel electrode 191 of the lower panel 100 and a common electrode 270 of the upper panel 200 as its two terminals, while the liquid crystal layer 3 between the two electrodes 191 and 270 functions as a dielectric material. The pixel electrode 191 is connected to the switching element Q. The common electrode 270 is formed on the whole surface of the upper panel 200 and receives a common voltage Vcom. In an alternative embodiment, the common electrode 270 may be formed on the lower panel 100, and at least one of the two electrodes 270 and 191 may have a linear shape or a bar shape.

A storage capacitor Cst that serves as an auxiliary to the liquid crystal capacitor Clc is formed where the pixel electrode 191 overlaps a separate signal line (not shown) provided on the lower panel 100, wherein an insulator is interposed between the pixel electrode and the separate signal line. A voltage, such as the common voltage Vcom, may be applied to the separate signal line. The storage capacitor Cst may also be formed by pixel electrode 191 and a previous gate line G(i-1) that are arranged to overlap each other, with an insulator interposed between the pixel electrode 191 and the previous gate line G(i-1).

For a color display, each pixel PX uniquely represents one of primary colors (i.e., spatial division) or each pixel PX sequentially represents the primary colors in turn (i.e., temporal division), such that a spatial or temporal sum of the primary colors is recognized as a desired color. An example of a set of the primary colors includes red, green, and blue. FIG. 3 shows an example of the spatial division in which each pixel PX includes a color filter 230 representing one of the primary colors in an area of the upper panel 200 facing the pixel electrode 191. Alternatively, the color filter 230 may be provided on or under the pixel electrode 191 on the lower panel 100.

At least one polarizer (not shown) for providing light polarization may be provided in the liquid crystal panel assembly 300.

Referring again to FIG. 1, the gray voltage generator 800 generates all gray voltages or a specific number of gray voltages (or reference gray voltages) related to transmittances of the pixels PX. The (reference) gray voltages may include one set having a positive value with respect to the common voltage Vcom, and another set having a negative value.

The data driver 400 is connected to the data lines D1 to Dm of the liquid crystal panel assembly 300, and selects gray voltages from the gray voltage generator 800 to apply them to the data lines D1-Dm as data voltages. When the gray voltage generator 800 does not supply all gray voltages but supplies only a limited number of reference gray voltages, the data driver 400 divides the reference gray voltages to generate data voltages. The data driver 400 receives a data control signal CONT2 from the signal controller 600.

The gate driver 500 is connected to the gate lines G1 to Gn of the liquid crystal panel assembly 300, and applies gate signals obtained by combining a gate-on voltage Von for turning on the switching elements Q and a gate-off voltage Voff for turning them off to the gate lines G1 to Gn. The gate driver 500 is integrated on the liquid crystal panel assembly 300 along with the signal lines G1-Gn and D1-Dm, and the thin film transistor switching elements Q, and includes a plurality of thin film transistors. The number of output terminals of the gate driver 500 is half the number of the gate lines G1-Gn.

The signal controller 600 controls the gate driver 500 and the data driver 400. The signal controller 600 receives input image signals Din and input control signals ICON, and transmits output image signals Dout and gate control signals CONT1 to the gate driver 500, and data control signals CONT2 to the data driver 400.

In this way, when a data driver is disposed on the right or left side of the assembly 300, and a gate driver is disposed on the upper or lower side, the number of data lines may be reduced compared with the opposite case when the data driver is disposed on the upper or lower side and the gate driver is disposed on the left or right side. Also, by joining two gate lines to form one output terminal of the gate driver, such that the gate driver includes the same number of output terminals as the corresponding number of the pairs of the gate lines, the structure of the gate driver may be simplified such that the area occupied by the gate driver may be reduced in the assembly 300. Also, the overall area of the assembly may be reduced.

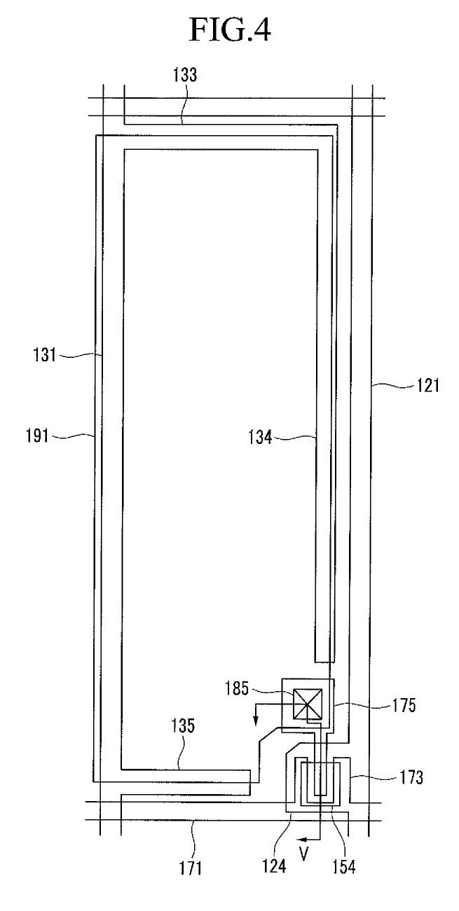

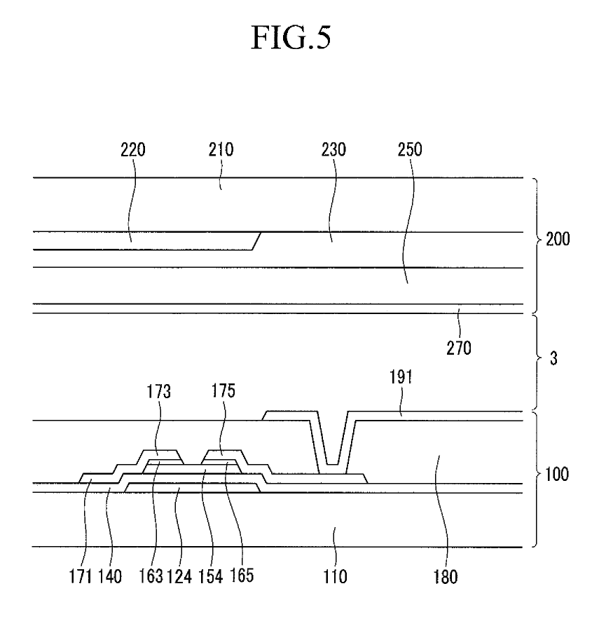

FIG. 4 is a layout view of a liquid crystal panel assembly according to an exemplary embodiment of the present invention, and FIG. 5 is a cross-sectional view of the liquid crystal panel assembly shown in FIG. 4 taken along the line V-V.

As shown in FIG. 5, a liquid crystal panel assembly according to an exemplary embodiment includes a lower panel 100, an upper panel 200, and a liquid crystal layer 3 interposed between.

First, the lower panel 100 will be described.

A plurality of gate lines 121 and a plurality of storage electrode lines 131 are formed on an insulating substrate 110 that may be made of transparent glass or plastic. Each of the gate lines 121 includes a plurality of gate electrodes 124 protruding from the gate lines. The gate electrodes 124 may protrude from the gate lines 121 in more than one direction, for example, in left or right directions. The storage electrode lines 131 include a plurality of protruding storage electrodes 133, 134, and 135.

A gate insulating layer 140 that may be made of, for example, silicon nitride (SiNx) or silicon oxide (SiOx) is formed on the gate lines 121 and the storage electrode lines 131.

A plurality of first semiconductor islands 154 that may be made of hydrogenated amorphous silicon (simply referred to as a-Si) or polysilicon, are formed on the gate insulating layer 140. The semiconductor islands 154 are disposed on the gate electrodes 124.

A plurality of ohmic contact islands 163 and 165 are formed on the semiconductor islands 154. The ohmic contacts 163 and 165 may be formed of n+ hydrogenated amorphous silicon heavily doped with an n-type impurity, or the ohmic contacts 163 and 165 may be made of silicide.

A plurality of data lines 171 and a plurality of drain electrodes 175 are formed on the ohmic contacts 163 and 165 and the gate insulating layer 140.

The data lines 171 intersect the gate lines 121, and may curve at least one time between two neighboring gate lines 121. The data lines 171 include a plurality source electrodes 173 extending from the data lines, for example, in upward or downward directions, toward the gate electrodes 124. The source electrodes 173 may have a “U” shape. The data lines 171 may curve near the source electrodes 173.

The drain electrodes 175 are separated from the data lines 171, and are positioned opposite the source electrodes 173 with reference to the gate electrodes 124. Each drain electrode 175 includes one end portion having a wide area and another end portion having a bar shape, and the bar-shaped end portion is enclosed by the source electrode 173.

A gate electrode 124, a source electrode 173, and a drain electrode 175 form a thin film transistor (TFT) Q along with a semiconductor island 154. The channel of the thin film transistor Q is formed in the semiconductor island 154 between the source electrode 173 and the drain electrode 175.

The ohmic contacts 163 and 165 are interposed only between the underlying semiconductor islands 154 and the overlying data lines 171 (including the source electrodes 173) and the drain electrodes 175 thereon, and reduce contact resistance between the underlying semiconductor islands 154 and the overlying data lines 171 and drain electrodes 175. The semiconductor islands 154 include exposed portions that are not covered by the source electrodes 173 and the drain electrodes 175, such as portions that are disposed between the source electrodes 173 and the drain electrodes 175.

A passivation layer 180 is formed on the data lines 171 (including the source electrodes 173), the drain electrodes 175, and the exposed semiconductor islands 154.

The passivation layer 180 may be made of an inorganic insulator or an organic insulator, and may have a flat surface. The passivation layer 180 has a plurality of contact holes 185 exposing the drain electrodes 175. A plurality of pixel electrodes 191 are formed on the passivation layer 180. The pixel electrodes 191 may be made of a transparent conductive material such as ITO or IZO, or a reflective conductive material such as aluminum (Al), silver (Ag), chromium (Cr), or alloys thereof.

Next, the upper panel 200 will be described.

A light blocking member 220 is formed on an insulating substrate 210 that may be made of a material such as transparent glass. The light blocking member 220 is also referred to as a black matrix and prevents light leakage between the pixel electrodes 191.

A color filter 230 is also formed on the substrate 210. The color filter 230 is disposed substantially in the area enclosed by the light blocking member 220, and may extend substantially in the direction along the row of the pixel electrodes 191.

An overcoat 250 is formed on the color filter 230 and the light blocking member 220. The overcoat 250 may be made of an insulating material, such as an organic insulating material and prevents the color filter 230 from being exposed and provides a flat surface. The overcoat 250 may be omitted.

A common electrode 270 is formed on the overcoat 250. The common electrode 270 may be made of a transparent conductive material, such as ITO and IZO.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
a plurality of pixels arranged in a matrix shape, each of the pixels having a length in a row direction less than a length in a column direction;
a plurality of gate lines extending in the column direction;
a plurality of data lines extending in the row direction;
a gate driver connected to the gate lines and generating a gate signal; and
a data driver connected to the data lines and transmitting data signals,
wherein two adjacent gate lines are connected to each other to form a plurality of pairs of gate lines.

2. The liquid crystal display of claim 1, wherein
two data lines are disposed along the same pixel row, and connected to the pixels in the same pixel row.

3. The liquid crystal display of claim 2, wherein
the two data lines are respectively disposed above and below the same pixel row.

4. The liquid crystal display of claim 2, wherein
the two data lines are disposed on the same plane.

5. The liquid crystal display of claim 2, wherein
each of the pixels includes a switching element connected to the gate line and the data line, and a liquid crystal capacitor connected to the switching element and
the switching elements are alternately disposed at a top of the pixel and at a bottom of the pixel in each pixel row.

6. The liquid crystal display of claim 5, wherein
each pixel further includes a storage capacitor connected to the switching element in parallel with the liquid crystal capacitor.

7. The liquid crystal display of claim 1, further comprising
a plurality of storage electrode lines extending in the column direction,
wherein each of the pixels includes
a switching element connected to the gate line and the data line, and
a pixel electrode connected to the switching element and overlapping the storage electrode line.

8. The liquid crystal display of claim 7, wherein
the storage electrode line includes a storage electrode extending along an edge of the pixel electrode and overlapping the pixel electrode.

9. A liquid crystal display, comprising:
a plurality of pixels arranged in a matrix shape, each of the pixels having a length in a row direction less than a length in a column direction;
a plurality of gate lines extending in the column direction;
a plurality of data lines extending in the row direction;
a gate driver connected to the gate lines and generating a gate signal; and
a data driver connected to the data lines and transmitting data signals, wherein the gate driver has output terminals, and a number of the output terminals is less than a number of the gate lines.

10. The liquid crystal display of claim 9, wherein
the number of the output terminals of the gate driver is half the number of the gate lines.

11. The liquid crystal display of claim 10, wherein
two neighboring gate lines are connected to one output terminal of the gate driver.

12. The liquid crystal display of claim 11, wherein
the gate driver includes a plurality of thin film transistors.

13. The liquid crystal display of claim 10, wherein
two data lines are disposed along the same pixel row, and connected to pixels in the same pixel row.

14. The liquid crystal display of claim 13, wherein
the two data lines are respectively disposed above and below the same pixel row.

15. The liquid crystal display of claim 13, wherein
the two data lines are disposed on the same plane.

16. The liquid crystal display of claim 13, wherein
each of the pixels includes a switching element connected to the gate line and the data line, and a liquid crystal capacitor connected to the switching element, and
the switching elements are alternately disposed at a top of the pixel and at a bottom of the pixel in each pixel row.

17. The liquid crystal display of claim 16, wherein each pixel further includes a storage capacitor connected to the switching element in parallel with the liquid crystal capacitor.

18. The liquid crystal display of claim 10, further comprising
a plurality of storage electrode lines extending in the column direction,
wherein each of the pixels includes
a switching element connected to the gate line and the data line, and
a pixel electrode connected to the switching element and overlapping the storage electrode line.

19. The liquid crystal display of claim 18, wherein
the storage electrode line includes a storage electrode extending along an edge of the pixel electrode and overlapping the pixel electrode.
